(19) United States
(12) Patent Application Publication
(10) Pub. No.: US 2008/0236306 A1
(43) Pub. Date: Oct. 2, 2008

(54) SYSTEM AND METHOD FOR REDUCING CONVECTION CURRENT EFFECTS IN THE OPTICAL PATH OF A HOLOGRAPHIC INTERFEROMETRY SYSTEM

(76) Inventors: Michael J. Mater, Chelsea, MI (US); Alex Klooster, Ann Arbor, MI (US); Greg Dale, Novi, MI (US)

Correspondence Address: SCHOX PLC, 730 Florida Street #2, San Francisco, CA, 94110, US

(21) Appl. No.: 11/865,656

(22) Filed: Oct. 1, 2007

Related U.S. Application Data
(60) Provisional application No. 60/827,704, filed on Sep. 30, 2006.

(51) Int. Cl. G01N 17/00

(52) U.S. Cl. 73/865.6

(57) ABSTRACT

The invention includes a system and method for reducing convection current effects in the optical path of a holographic interferometer system. The system preferably includes an enclosure for the optical path of the holographic interferometer system. In one embodiment, the system also includes a thermal element coupled to or located inside the enclosure. In another embodiment, the system also includes a gas located inside the enclosure, wherein the gas has a lower index of refraction than air. In another embodiment, the system also includes a fan coupled to or located inside the enclosure and adapted to circulate a gas inside the enclosure.

### CROSS-REFERENCE TO RELATED APPLICATIONS

This application claims the benefit of U.S. Provisional Application No. 60/827,704, filed 30 Sep. 2006 and entitled “Method and Apparatus for Removing Convection Current Effects in the Optical Path of a Synthetic Wavelength Multifrequency Holographic Imaging System”, which is incorporated in its entirety by this reference.

### TECHNICAL FIELD

This invention relates generally to the holographic imaging field, and more specifically to a new and useful system and method for reducing and/or removing convection current effects the optical path of a holographic interferometry system.

### BACKGROUND

Interferometers are sensitive to air currents and variations of the temperature (and thus the index of refraction and optical path length) of the air in the optical path. In a laboratory setting, the temperature inside of a holographic interferometry system is carefully controlled, or even the optical path is evacuated to an ultra high vacuum. However, an interferometric imaging system in a factory must allow for opening the apparatus to insert parts to be measured and for variations in ambient temperature as the doors are opened and closed. In some cases, the parts to be measured are still hot from a previous manufacturing operation.

Warm parts in a manufacturing environment are particularly difficult to measure with holographic interferometry, as they will create convection currents that alter the length of the optical path. A visual example of this is the wavering effect observed in the distance on a hot day, or above a fire. The observed wavering effect is a convection current, which causes a change in the optical path length that the eye sees. Interferometry is much more sensitive to temperature changes and convection currents and a slightly warm part (or even sunlight going behind a cloud) will create convection currents and temperature changes that will alter the optical path length.

The non-uniform temperatures of the apparatus, parts, and atmosphere in the optical path lead to drifts of phase during the measurement. These drifts of phase can make it impossible to produce synthetic phase images where at a single wavelength, images must be taken as the phase of the object or reference beam is changed on the order of 10 times, and such measurements must be made for, in some cases, 16 wavelengths. During the entire time that 160 images are taken, the optical path length in the machine should vary by no more than a fraction of a wavelength of the measuring light. Thus, there is a need in the holographic imaging field to create a new and useful system and method for reducing and/or removing convection current effects the optical path of a holographic interferometry system. This invention provides such a new and useful method and apparatus.

### BRIEF DESCRIPTION OF THE FIGURES

FIG. 1 is a schematic representation of the prior art, more specifically of a holographic interferometer system.

FIG. 2 is a schematic representation of a first preferred embodiment of the invention.

FIG. 3 is a schematic representation of a second preferred embodiment of the invention.

FIG. 4 is a schematic representation of a third preferred embodiment of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

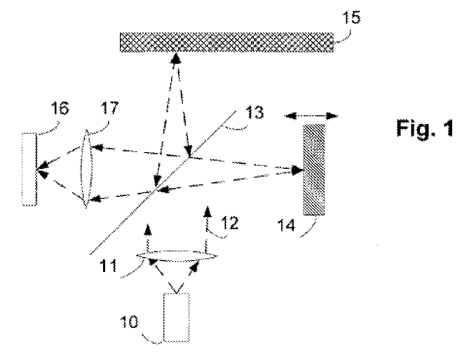

As shown in FIG. 1, a conventional interferometer system includes a light source 10, which produces light output which is converted into a beam 12 by a lens 11. The beam 12 is split by a beamsplitter 13 into two parts, one part illuminates an object 15 and the other part illuminates a reference surface 14. The reference surface 14 may be a specularly reflecting surface, a diffusely scattering surface, or any combination of the two. Light scattered from the reference surface 14 and the object 15 is combined at the beamsplitter 13 and propagates to the lens 17, which images both the surface of the object 15 and the surface of the reference surface 14 on to an image detector 16. The interferometer system is described in U.S. Patent Application 2007/0024867, which is incorporated in its entirety by this reference.

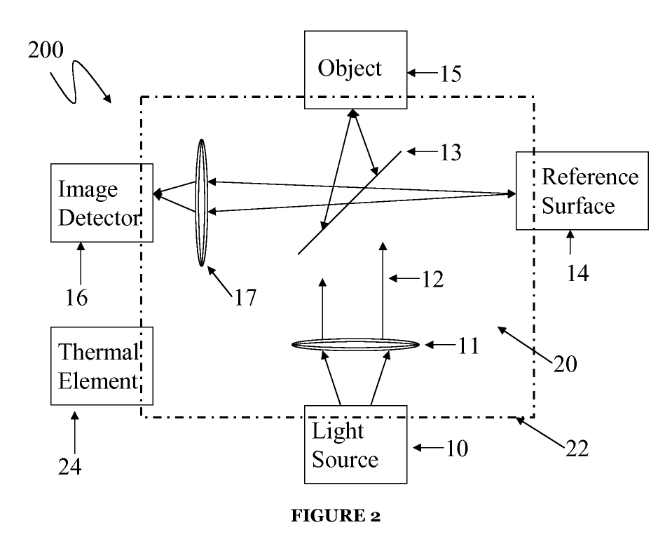

As shown in FIG. 2, a first preferred embodiment of a system 200 for reducing or removing convection current effects in the optical path 20 of a holographic interferometry system includes an enclosure 22 for the optical path of the holographic interferometer system, and a thermal element 24.

The enclosure 22 functions to enclose and substantially seal the optical path such that external currents or conditions do not affect the temperature and controlled convection currents in the optical path. More preferably, the enclosure 22 is hermetically sealed. The enclosure 22 is preferably 50 cm by 50 cm and 1 m high, but may be any suitable shape and size. The enclosure 22 is preferably made of a metal and insulation, but may be made from any suitable material. The enclosure 22 preferably has a door or latch or any other suitable mechanism to allow the insertion of parts or objects to measure. The enclosure 22 may additionally or alternatively be raised and lowered to enclose newly manufactured parts, which may still be warm from a prior manufacturing process, on a conveyor belt or on the assembly line. The enclosure 22 preferably encloses the lens 11, the beamsplitter 13, and the lens 17, and at least seals against (if not completely encloses) the light source 10, the reference surface 14, the object 15, and the image detector 16. One reason that a smaller enclosure is more preferable, is that it requires less energy and takes less time to create an inversion layer and/or circulate the air to create a uniform temperature, enabling faster and more efficient measurements.

The thermal element 24 functions to add heat to the top of the enclosure 22 and to establish an inversion layer in the enclosed optical path 20 that substantially eliminates the convection currents, through meteorological effects. The thermal element is preferably an electrical heater element, but may alternatively be any suitable thermal element that adds heat to the enclosure. The addition of as little as 10 watts of heat energy can be adequate to establish an inversion layer in the enclosure 22 measuring 50 cm by 50 cm, and approximately 1 m high. The enclosure preferably at least seals against (if not completely encloses) the thermal element 24.

The system 200 of the first preferred embodiment may also include a thermometer and a processor. The thermometer, which is coupled to or inside of the enclosure, functions to measure the temperature at one or more points inside of the enclosure and a processor. The processor, which is coupled to the thermometer and to the thermal element, functions to control the thermal element and to establish the inversion layer.

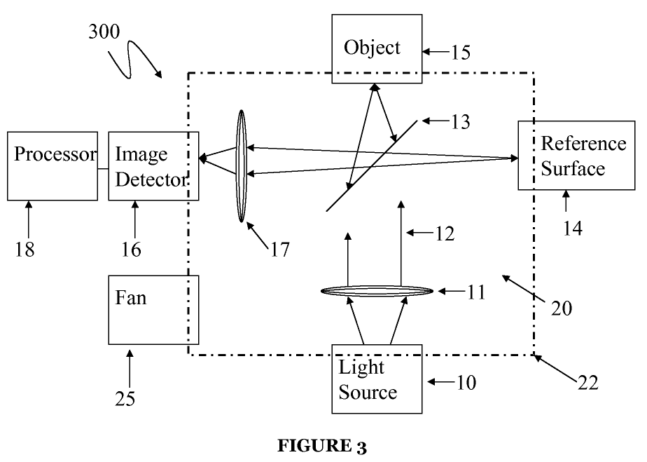

As shown in FIG. 3, a second preferred embodiment of a system 300 for removing convection current effects in the optical path 20 of a holographic interferometry system includes an enclosure 22, and a fan 25. The enclosure 22 of the second embodiment is preferably identical to the enclosure of the first preferred embodiment.

The fan 25 functions to mix the gas inside of the enclosure 22, and to create a substantially uniform temperature throughout the gas inside of the enclosure. The fan 25 preferably mixes the gas inside of the enclosure 22 rapidly enough to disrupt any convection currents that might be generated by conditions in the enclosure 22, such as the insertion of newly manufactured parts that may still be warm from the manufacturing process, and to result in a substantially more uniform temperature within the enclosure 22. The system 300 preferably includes more than one fan 25, but may only include one fan 25. The fan 25 is preferably located inside of the enclosure 22, but may alternatively be located at a remote location and connected via conduits or any other suitable connection. The fan 25 is preferably mechanically isolated from the holographic interferometry system, such that the vibration of the fan 25 is not transmitted to the supports of the optical components.

One preferred variation of the second preferred embodiment of the invention includes a processor 18, which functions to calculate the phase differences. If the uniform temperature in the optical enclosure 22 drifts slowly, it looks like a drift of phase in the reference arm, which can be offset by calculating the phase differences from the statistics of the pixel values, as long as the temperature drift is preferably not more than ¼ phase per camera cycle (125 ms).

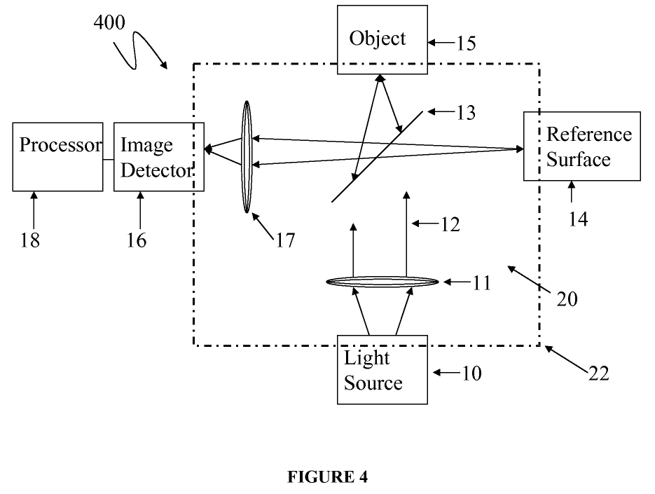

As shown in FIG. 4, a third preferred embodiment of a system 400 for removing convection current effects in the optical path 20 of a holographic interferometry system includes an enclosure 22 and a gas in the optical path 20. The enclosure 22 of the second embodiment is preferably identical to the enclosure of the first preferred embodiment.

The gas in the optical path 20 functions to reduce the index of refraction and/or increase the heat conductivity relative to air. If the gas reduces the index of refraction relative to air, then the temperature variation of the gas is of less significance. If the gas increase the heat conductivity relative to air, then the gas become more uniform and can be offset through calculations. Since helium has both a lower index of refraction and a higher heat conductivity than air, helium is the preferred gas. The gas may, however, be any gas that satisfies at least one of the two criteria.

As a person skilled in the art will recognize from the previous detailed description and from the figures and claims, modifications and changes can be made to the preferred embodiments of the invention without departing from the scope of this invention defined in the following claims.

We claim:

1. A system for reducing convection current effects in the optical path of a holographic interferometer system, comprising:
an enclosure for the optical path of the holographic interferometer system; and
a thermal element coupled to or located inside the enclosure and adapted to create an inversion layer in the enclosure.

2. The system of claim 1, wherein the thermal element is an electric heater.

3. The system of claim 2, further comprising a thermometer coupled to or located inside the enclosure and adapted to measure a temperature within the enclosure.

4. The system of claim 3, further comprising a processor coupled to the thermometer and the thermal element and adapted to control the thermal element based on the measured temperature within the enclosure.

5. A method for reducing convection current effects in the optical path of a holographic interferometer system, comprising the steps of:
providing an enclosure for the optical path of the holographic interferometer system; and
creating an inversion layer in the enclosure.

6. A system for reducing convection current effects in the optical path of a holographic interferometer system, comprising:
an enclosure for the optical path of the holographic interferometer system; and
a gas located inside the enclosure, wherein the gas has a lower index of refraction than air.

7. The system of claim 6, wherein the gas is Helium.

8. A system for reducing convection current effects in the optical path of a holographic interferometer system, comprising:
an enclosure for the optical path of the holographic interferometer system; and
a fan coupled to or located inside the enclosure and adapted to circulate a gas inside the enclosure.

9. The system of claim 8, wherein the fan is mechanically insulated from the holographic interferometer system.

10. The system of claim 8, wherein the fan circulates the gas at a rate of circulation to ensure that the temperature of the optical path is substantially uniform.

11. The system of claim 8, further comprising a thermometer coupled to or located inside the enclosure and adapted to measure a temperature inside the enclosure.

12. The system of claim 11, further comprising a processor coupled to the thermometer, wherein the processor calculates a phase drift due to drift of the temperature in the enclosure.

13. The system of claim 12, wherein the calculated phase drift is used by a processor to adjust the phase measurements by the holographic interferometer system.

14. A method for reducing convection current effects in the optical path of a holographic interferometer system, comprising the steps of:
providing an enclosure for the optical path of the holographic interferometer system;
circulating a gas inside the enclosure at a rate of circulation to ensure that the temperature of the optical path is substantially uniform;
measuring a drift in the temperature inside the enclosure;
calculating the phase drift from the uniform temperature drift; and
adjust the phase measurements by the holographic interferometer system.
